(19) United States
(12) Patent Application Publication
(10) Pub. No.: US 2022/0291007 A1
(43) Pub. Date: Sep. 15, 2022

(54) METHOD, DEVICE, MEDIUM, AND PROGRAM PRODUCTS FOR INFORMATION DISPLAY

(71) Applicant: MOBILITY ASIA SMART TECHNOLOGY CO. LTD., Beijing (CN)

(72) Inventors: Huirong Yang, Beijing (CN); Penghujing Luo, Beijing (CN); Xinxing Chen, Beijing (CN); Piaohai Yao, Beijing (CN)

(21) Appl. No.: 17/695,307

(22) Filed: Mar. 15, 2022

(30) Foreign Application Priority Data
Mar. 15, 2021 (CN) 202110276504.6

(51) Int. Cl. G01C 21/36

(52) U.S. Cl. CPC G01C 21/3617; G01C 21/3679; G01C 21/3614

(57) ABSTRACT

According to an example embodiment of the present disclosure, a method for information display, a device, a medium and a program product are provided. The method for information display includes: acquiring a context associated with at least one of a terminal device and a user; determining, on the basis of the context, a navigation scenario in which the user navigates by using the terminal device; and determining, on the basis of the navigation scenario, a map mode of a map that is displayed in a user interface of a display system of the terminal device. In this way, information to be displayed can be dynamically changed according to different navigation scenarios. Therefore, information display better conforms to the navigation scenarios.

### TECHNICAL FIELD

Embodiments of the present disclosure generally relate to the field of computers, and more particularly to a method for information display, a device, a computer-readable storage medium and a computer program product.

### BACKGROUND

In addition to the navigation demands of arriving at destinations correctly, users also need a lot of other trip-related information during a travel process, so as to assist them in making better travel decisions. For example, the users may need to know various trip-related information, such as business states and scores of restaurants, available transport means facilities (such as gas stations, car washes, charging piles, parking lots, and so on), weather, holidays and festivals, etc. When the users have different travel intentions, they need different information, so there are a variety of travel scenarios or navigation scenarios. For example, when the users go out and travel at night, the information they need varies greatly. Therefore, there is a need for a smarter and richer personalized information recommendation and display solution suitable for the navigation scenarios, so as to recommend to the users information that better conforms to the current navigation scenario.

### SUMMARY

According to an exemplary embodiment of the present disclosure, a solution for information display is provided, so as to realize information display that is more intelligent and better conforms to user demands.

In a first aspect of the present disclosure, a method for information display is provided. The method includes: acquiring a context associated with at least one of a terminal device and a user; determining, on the basis of the context, a navigation scenario in which the user navigates by using the terminal device; and determining, on the basis of the navigation scenario, a map mode of a map that is displayed in a user interface of a display system of the terminal device.

In a second aspect of the present disclosure, an electronic device is provided. The electronic device includes: at least one processing unit; and at least one memory, wherein the at least one memory is coupled to the at least one processing unit and stores instructions executed by the at least one processing unit, and when executed by the at least one processing unit, the instructions enable the device to execute actions. The actions include: acquiring a context associated with at least one of a terminal device and a user; determining, on the basis of the context, a navigation scenario in which the user navigates by using the terminal device; and determining, on the basis of the navigation scenario, a map mode of a map that is displayed in a user interface of a display system of the terminal device.

In a third aspect of the present disclosure, a computer-readable storage medium is provided, wherein a computer program is stored thereon, and when executed by a device, the computer program causes the device to execute the method according to the first aspect of the present disclosure.

According to a fourth aspect of the present disclosure, a computer program product is provided. The computer program product includes a computer program, and when executed by a processor, the computer program implements the method of the first aspect.

It should be understood that, the content described in the Summary of the present invention is not intended to limit key features or critical features of the embodiments of the present disclosure, nor is it intended to limit the scope of the present disclosure. Other features of the present disclosure will become readily understood from the following description.

### BRIEF DESCRIPTION OF THE DRAWINGS

The above and other features, advantages and aspects of various embodiments of the present disclosure will become more apparent in combination with the drawings and with reference to the following detailed description. In the drawings, the same or similar reference signs refer to the same or similar elements, wherein:

FIG. 1 shows a schematic diagram of an example environment according to an embodiment of the present disclosure;

FIG. 2 shows a flow diagram of a process for information display according to some embodiments of the present disclosure;

FIG. 3 shows a schematic diagram of an example information display process according to some embodiments of the present disclosure;

FIG. 4 shows an example of a user interface for displaying recommendation information on the basis of a layout according to some embodiments of the present disclosure;

FIG. 5 shows a flow diagram of a process for generating recommendation information according to some embodiments of the present disclosure;

FIG. 6 shows a schematic diagram of an example recommendation information generation process according to some embodiments of the present disclosure; and

FIG. 7 shows a block diagram of an electronic device capable of implementing a plurality of embodiments of the present disclosure.

### DETAILED DESCRIPTION OF THE EMBODIMENTS

The embodiments of the present disclosure will be described in more detail below with reference to the drawings. Although some embodiments of the present disclosure are shown in the drawings, it should be understood that, the present disclosure can be implemented in various forms and should not be construed as limited to the embodiments set forth herein, but on the contrary, these embodiments are provided for a more thorough and complete understanding of the present disclosure. It should be understood that, the drawings and embodiments of the present disclosure are only for exemplary purposes, and are not intended to limit the protection scope of the present disclosure.

In the description of the embodiments of the present disclosure, the term “including” and similar terms should be understood as open-ended inclusions, that is, “including but not limited to”. The term “based on” should be understood as “at least partially based on”. The term “one embodiment” or “the embodiment” should be understood as “at least one embodiment”. The term “some embodiments” should be understood as “at least some embodiments.” Other explicit and implicit definitions may also be included below.

As mentioned above, there is a need for a smarter and richer personalized information recommendation and display solution suitable for a navigation scenario.

On one hand, the information that can be provided by a display interface of a display system of a traditional terminal device is usually limited. For example, during the travel of a user of a transport means, only simple navigation information is provided. As an example, the navigation information can include the current position of the user, the destination of the user, and a route from the current position to the destination. On the other hand, third-party information providers, such as content providers or service providers, are usually used for meeting the use of mobile phone users and are independent of each other. For example, a delicious food application only provides delicious food information, while a weather application only provides weather information, etc. However, the traditional display system cannot well integrate various information from different third-party information providers. At least for the above reasons, the traditional display system cannot provide differentiated, smarter and richer personalized information recommendation and display suitable for the navigation scenario.

According to an embodiment of the present disclosure, a solution for improving information display of a terminal device is proposed. In the solution, a context associated with at least one of a terminal device and a user can be acquired. Based on the context, a navigation scenario in which the user navigates by using the terminal device can be determined. Thereby, on the basis of the navigation scenario, a map mode of a map that is displayed in a user interface of a display system of the terminal device can be determined. According to the solution, the map mode can be dynamically changed according to different navigation scenarios. For this reason, the displayed information is more suitable for the navigation scenario, the user can better acquire information needed in the current navigation scenario, and the intelligence of onboard display is improved.

An example embodiment of the present disclosure will be described in detail below with reference to the drawings.

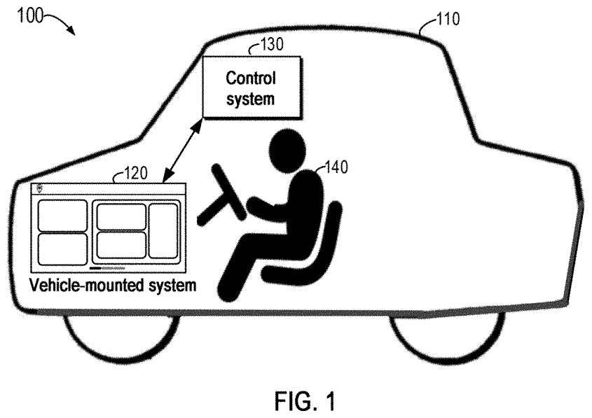

FIG. 1 shows a schematic diagram of an example environment 100 according to an embodiment of the present disclosure. The example environment 100 includes a transport means 110 and a vehicle-mounted system 120. The vehicle-mounted system 120 has a display system, such as a display screen, for displaying information to a user 140 (e.g., a vehicle driver or passenger).

As used herein, the transport means 110 refers to any type of transport means that is capable of carrying people and/or things and is movable. In FIG. 1 and other drawings and descriptions herein, the transport means 110 is illustrated as a vehicle. The vehicle can be a motor vehicle or a non-motor vehicle, examples of which include, but are not limited to, cars, saloon cars, trucks, buses, electric vehicles, motorcycles, bicycles, and so on. However, it should be understood that, the vehicle is only an example of the transport means. The embodiment of the present disclosure is also applicable to other transport means in addition to vehicles, such as boats, trains, airplanes, etc.

As shown in FIG. 1, the present invention is described by taking the vehicle-mounted system 120 as an example. However, the present invention is not limited thereto, and other systems with navigation functions and display systems can implement the present invention, such as a device held by the user 140, or any terminal device deployed at any suitable position (e.g., offices, homes, or hotels, and so on). In some embodiments, the terminal device can be an integrated display device, a smartphone, a tablet computer, a notebook computer, a wearable device, or any other suitable computing devices. Hereinafter, the vehicle-mounted system 120 will be taken as an example for description. However, it should be understood that, the operations described below can also be applicable to any terminal device.

The presentation of information in the display system of the vehicle-mounted system 120 is controlled by a control system 130 thereof. The vehicle-mounted system 120 can provide a human-machine interaction interface (HMI), and various types of information are presented to a user, such as the user 140, by means of its user interface. In some embodiments, the user 140 can be located inside the transport means 110. Alternatively, the user 140 can also be located outside the transport means 110. The position of the user 140 is not limited by the transport means 110.

The control system 130 of the vehicle-mounted system 120 can be included in an embedded system inside the transport means 110, for example, be embedded in a central control system of the transport means 110. In some embodiments, the control system 130 cannot be embedded in the transport means 110, but is an external stand-alone system or device.

In some embodiments, the control system 130 can include or can be implemented on any electronic device with computing capability. Examples of such electronic device include, but are not limited to, servers, mainframes, edge computing nodes, mobile handsets, personal computers, computing devices in cloud environments, etc.

It should be understood that, FIG. 1 only schematically shows objects, units, elements, or components related to the embodiment of the present disclosure. In practice, the example environment 100 can also include other objects, units, elements, or components, etc. In addition, the particular numbers of the objects, units, elements or components shown in FIG. 1 are illustrative only and are not intended to limit the scope of the present disclosure in any way. In other embodiments, the example environment 100 can include any suitable number of objects, units, elements, or components, etc. Furthermore, although FIG. 1 shows the user 140 at a driving position, one or more other users, such as passengers, can also be present in the transport means 110. Accordingly, the embodiment of the present disclosure is not limited to the specific scenario depicted in FIG. 1, but is generally applicable to any technical environment in which a transport means carries an onboard electronic device.

Some embodiments of the present disclosure will be described in more detail below with reference to the drawings.

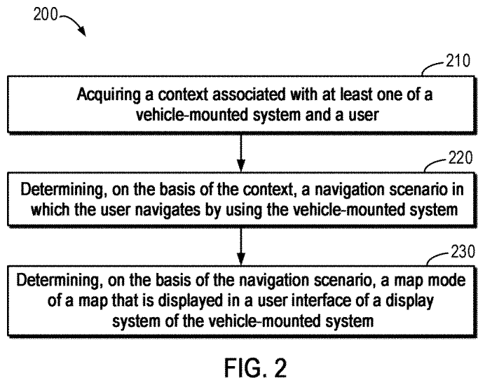

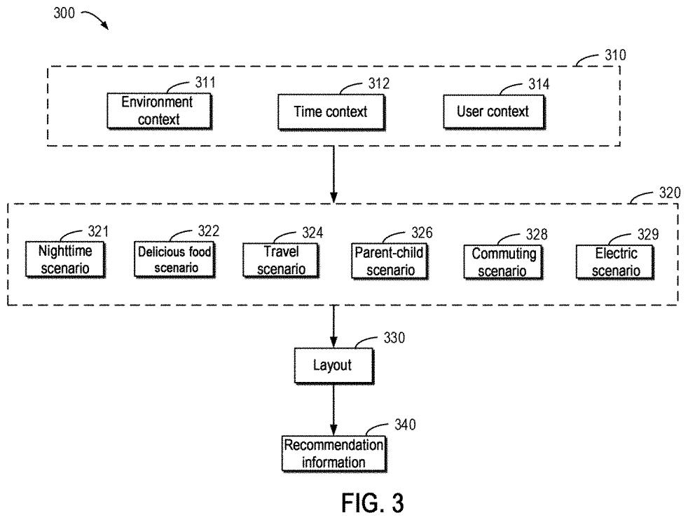

FIG. 2 shows a flow diagram of a process 200 for information display according to some embodiments of the present disclosure. The process 200 can be implemented by the control system 130 in FIG. 1. For the convenience of discussion, the description will be made with reference to FIG. 1 and FIG. 3, wherein FIG. 3 shows a schematic diagram of an example information display process 300 according to some embodiments of the present disclosure.

At a block 210, the control system 130 acquires a context associated with at least one of the vehicle-mounted system 120 and the user 140. For example, as shown in FIG. 3, the context 310 can include an environment context 311, a time context 312, and/or a user context 314, etc.

In some embodiments, the environment context 311 indicates information associated with an environment that is associated with the operation of the transport means 110. In one embodiment, the environmental context 311 can indicate information associated with an external environment where the transport means 110 is located, for example, current position information, destination information, traffic conditions, weather conditions, etc. Alternatively or additionally, the environment context 311 can also indicate, for example, information associated with an operating environment of the transport means 110. The control system 130 can acquire the environment context 311 related to the transport means 110 on the basis of a connection with the transport means 110, for example, the type (e.g., fuel vehicle or electric vehicle), fuel state, electric quantity state, travel speed, or maintenance state (e.g., vehicle maintenance is required), violations of the transport means 110, etc. In some embodiments, the control system 130 can acquire the environment context 311 by means of, for example, a sensor coupled thereto, or acquire the corresponding environment context 311 from a server by using, for example, a communication device coupled thereto.

In some embodiments, the time context 312 indicates information of time associated with the operation of the transport means 110. The time context 312 can include, for example, the current specific moment (e.g., 15:30), the current time period (e.g., afternoon), the current date (e.g., Oct. 22, 2019), etc. As another example, the time context 312 can further include other information for indicating time, for example, whether it is a workday, whether it is a holiday, whether it is in a on-duty commuting time period, whether it is in an off-duty commuting time period, etc.

In some embodiments, the user context 314 indicates information associated with the user of the transport means 110. For example, the user can include the current driver of the transport means 110, such as the user 140. Alternatively, the user can further include other passengers inside the transport means 110. In some embodiments, the user context 314 can include, for example, gender, occupation, home address, company address, schedule, preference, historical driving data, historical service access data, historical operating data of the vehicle-mounted system of the user, and another information that may be related to the user. The transport means 110 can acquire the user context 314, for example, by means of an application (e.g., a schedule application or a navigation application or the like) installed thereon or on an electronic device coupled thereto, and/or can determine the corresponding user context 314 by means of user registration information.

It should be understood that, in addition to the example contexts listed above, the “context” in the present disclosure can include any other suitable contexts used for indicating information associated with the transport means 110 and/or the user 140. Different types of contexts can be determined by sensors provided in association with the transport means 110, or can be determined by information provided by external sources.

At a block 220, the control system 130 determines, on the basis of the context 310, a navigation scenario 320 in which the user 140 navigates by using the vehicle-mounted system 120. Different navigation scenarios 320 are associated with different demand modes of the user 140 when using the vehicle-mounted system 120.

For example, as shown in FIG. 3, the navigation scenario can include any suitable scenario such as a nighttime scenario 321, a delicious food scenario 322, a travel scenario 324, a parent-child scenario 326, a commuting scenario 328, and/or an electric scenario 329.

Specifically, as an example, the nighttime scenario 321 can be a scenario in which the user 140 drives the transport means 110 at nighttime or late at night. The delicious food scenario 322 can be a scenario in which the user 140 drives the transport means 110 during a meal time period, or the destination of the user 140 driving the transport means 110 is a shopping mall or a delicious food street. The travel scenario 324 can be a scenario in which the user 140 drives the transport means 110 in a remote city, or the destination of the user 140 is a tourist attraction.

The parent-child scenario 326 can be a scenario in which there is a child in the transport means 110 when the user 140 is driving the transport means 110, or the destination of the user 140 driving the transport means 110 is a kindergarten. The commuting scenario 328 can be a scenario in which the user 140 drives the transport means 110 in on-duty and off-duty time periods, or the destination of the user 140 driving the transport means 110 is a work unit. The electric scenario 329 can be a scenario in which the transport means 110 is an electric vehicle, or the remaining electric quantity of the transport means 110 is lower than threshold electric quantity when the user 140 is driving the transport means 110.

It should be understood that, the above navigation scenarios are only examples, the present invention is not limited thereto, and can be applicable to various appropriate navigation scenarios.

Further, in some embodiments, the control system 130 can determine the navigation scenario 320 on the basis of different contexts. For example, the nighttime scenario 321 can be determined by the time context 312. The delicious food scenario 322, the travel scenario 324, the commuting scenario 328 and the electric scenario 329 can be determined by the environment context 311. The parent-child scenario 326 can be determined by the user context 314. In some embodiments, control system 130 can determine the navigation scenario 320 on the basis of a combination including a plurality of contexts. For example, the travel scenario 324 can be determined by both the environment context 311 and the user context 314.

At a block 230, the control system 130 determines, on the basis of the navigation scenario 320, a map mode of a map that is displayed in a user interface of a display system of the vehicle-mounted system 120. As described above, in different navigation scenarios 320, the user 140 may pay attention to or actually need different types of information. Since the user 140 manually screens and switches the content of attention during driving, it may lead to distracted driving, which may easily lead to dangerous driving behaviors. Therefore, according to the embodiments of the present disclosure, the map mode is dynamically changed according to the navigation scenario 320, thereby automatically displaying, to the user 140, information better conforming to demands in an intelligent manner. In this way, the user 140 can easily acquire the currently needed information, and the intelligence of onboard display is thus improved.

Some examples of the map mode will be described herein. For example, a lot of service providers such as shops or restaurants are not open late at night. Therefore, in the nighttime scenario 321, the user 140 may pay more attention to whether he can achieve his intended activity or task after arriving at the destination late at night. In this case, the map mode in the nighttime scenario 321 can highlight service providers that are open, or provide business hours of various service providers, and the like. The map mode in the delicious food scenario 322 can highlight hot restaurants, or provide scores, specialties, delicious food types and the like of restaurants in shopping malls or delicious food streets. In the travel scenario 324, the user 140 may pay more attention to whether tourist attractions are worth visiting, whether the scheduling is reasonable, and so on. Therefore, the map mode in the travel scenario 324 can provide scores of tourist attractions, and position information of various service providers such as restaurants and hotels in the vicinity of the tourist attractions.

In the parent-child scenario 326, there is a child inside the transport means 110. Accordingly, the map mode in the parent-child scenario 326 can provide information of places and services suitable for children, such as information of zoos, museums, playgrounds, and the like. In the commuting scenario 328, the user 140 may be relatively familiar with roads between the current position and the destination. Therefore, the user 140 may pay more attention to road conditions to the destination and desire a faster and more time-saving route. Thus, the map mode in the commuting scenario 328 can provide current road conditions and optimal routes. In the electric scenario 329, a significant difference between an electric vehicle and a fuel vehicle is the concern about the remaining electric quantity. Therefore, the map mode in the electric scenario 329 can provide real-time changes in electric quantity, positions of charging piles, idle conditions of the charging piles, power levels of the charging piles and the like, or provide pop-up warnings in the case of low electric quantity.

To implement such a map mode, in some embodiments, the control system 130 can determine, on the basis of the navigation scenario 320, recommendation information 340 for the navigation scenario 320 and associated with the map, and a layout 330 of the recommendation information in the user interface. Further, the control system 130 can display, on the basis of the layout 330, the recommendation information 340 in the user interface, so as to generate the map mode.

Thus, the control system 130 can determine, on the basis of the navigation scenario 320, to recommend what information to the user 110, and how to present the recommendation information 340 in the user interface of the display system of the vehicle-mounted system 120 in an appropriate layout 330.

As used herein, the “layout” refers to an arrangement manner of the information in the user interface. Different layouts can enable the information to be presented in the user interface of the display system of the vehicle-mounted system 120 in different arrangement and combination manners.

Different layouts can be defined in a plurality of aspects, including the number of areas for information display in one page of the user interface, the sizes of the areas, the types of information displayed in different areas, as well as the number of areas for information display in different pages of the user interface, the sizes of the areas, the types of information displayed in different areas. Different layouts will allow the information to be combined and presented to the user in different ways, such that the user can mainly focus on different information, and the types of the information may also be different.

In some embodiments, the layout in the user interface of the display system of the vehicle-mounted system 120 can indicate a plurality of areas in one or more pages, and each area is used for displaying a corresponding type of information. Different areas can have corresponding sizes, depending on the size of the user interface of the display system of the vehicle-mounted system 120. One page can include one or more areas. The display system of the vehicle-mounted system 120 can include one or more pages, the user can switch between different pages, for example, the user switches the page by swiping with a finger or selecting a button in the case where the display system of the vehicle-mounted system 120 includes a touch screen.

In some embodiments, the control system 130 can select, on the basis of the navigation scenario 320, a target layout template from a plurality of predetermined layout templates. The target layout template can be used for the layout of the recommendation information 340 in the user interface of the display system of the vehicle-mounted system 120.

In some embodiments, a plurality of layout templates can be predetermined, and each layout template defines a plurality of areas for displaying a plurality of portions of the recommendation information 340, respectively. These areas can be areas for display in a single page or can include areas for respective display in a plurality of pages. In some embodiments, each layout template can also define the type of information suitable for display in each area. Different areas may have different sizes, and the plurality of portions of the recommendation information 340 may need to be customized for the areas with different sizes, so as to configure appropriate display content, including various visual elements of a program, controls and the like, for display in corresponding areas. Therefore, if the areas are defined in one layout template, then depending on the sizes of the areas, the type of information that can be presented in each area is also determined. In some embodiments, area targets with a plurality of sizes can be set, and a plurality of areas in each layout template can have areas with the same or different sizes. A plurality of applications that are about to display information on the display system of the vehicle-mounted system 120 can customize the information presentation for the areas with one or more sizes.

Due to the difference in the sizes and arrangement manners of the areas for information display in different layout templates, the types of information that can be displayed in each area may also be different, and the control system 130 can select, on the basis of the navigation scenario 320, a target layout template suitable for displaying the recommendation information 340.

In some embodiments, the control system 130 can also use different presentation manners for different types of recommendation information 340. For example, the recommendation information 340 can be classified into static information, dynamic information, driving information, etc.

The static information refers to information in which the display content does not change with time or position. Examples of the static information can include, but are not limited to: positions, business hours, comments, scores, consumption per person, service types, pictures of restaurants, etc. For example, the control system 130 can use a highlighted presentation manner for the static information, such as highlighting the business hours of the restaurants.

The dynamic information refers to information in which the display content changes with time and position. Examples of the dynamic information can include, but are not limited to: navigation information, the content of which changes when the transport means 110 is at different positions; and audio and/or video information, such as music, radio stations, voice broadcasts, television programs, and the like, the content play of which can be paused and played, and the playback can continue for a certain period of time. By automatically playing the dynamic information, such as automatically starting the navigation and automatically playing a radio station, the user operation is further simplified, and the current demands of the user are met, so that the user can get on the vehicle and leave immediately.

The driving information refers to information related to the driving of the transport means 110. Examples of the driving information can include, but are not limited to, remaining electric quantity information, charging prompt information, fatigue prompt information, dangerous driving behavior prompt information, etc. For example, the control system 130 can present the driving information by means of a pop-up window, or in voice.

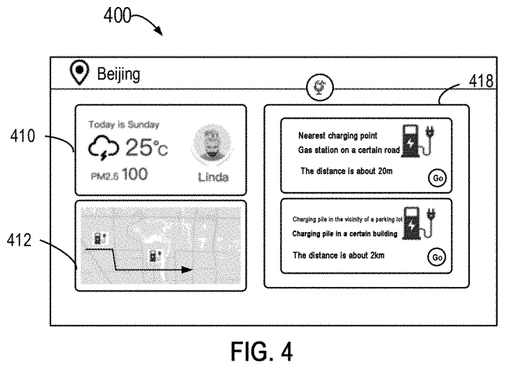

An example of the layout in the user interface of the display system of the vehicle-mounted system 120 will be described below in conjunction with FIG. 4. FIG. 4 shows an example of a user interface 400 for displaying the recommendation information on the basis of the layout according to some embodiments of the present disclosure.

In some embodiments, the control system 130 can determine, on the basis of the context 310, that the transport means 110 is currently in the electric scenario 329. The information that the map mode in the electric scenario 329 can present to the user includes weather information, navigation information for indicating the current position to the destination, position information of charging piles, etc.

As shown in the user interface 400 of FIG. 4, the layout indicates an area 410 for displaying weather information, an area 412 for displaying navigation information, and an area 418 for displaying the position information of charging piles. In the area 412 for displaying the navigation information, in addition to a navigation route, the positions of the charging piles on the map is also displayed. This is because, since the electric quantity of the vehicle will affect the normal operation, it needs to be displayed to the user at first. In addition, information worthy of the attention of the user, such as the navigation information and weather, also needs to be presented to the user.

It should be understood that, only one example of a possible layout is given above. It is also possible to set other layouts in different navigation scenarios. For example, it is also possible to set layouts corresponding to the nighttime scenario 321, the delicious food scenario 322, the travel scenario 324, the parent-child scenario 326, and/or the commuting scenario 328, etc.

After determining the layout 330 of the recommendation information 340, the control system 130 displays, on the basis of the determined layout 330, the recommendation information 340 in the user interface of the display system of the vehicle-mounted system 120. An example of the recommendation information 340 can refer to FIG. 4.

As described above, the recommendation information 340 can include various appropriate information associated with the current navigation scenario 320. As an example, in the nighttime scenario 321, the recommendation information 340 can include service providers that are open, or the business hours of various service providers, and the like. In the delicious food scenario 322, the recommendation information 340 can include hot restaurants, or provide scores, specialties, delicious food types and the like of the restaurants in shopping malls or delicious food streets. In the travel scenario 324, the recommendation information 340 can include scores of tourist attractions, and the position information of various service providers such as restaurants and hotels in the vicinity of the tourist attractions. In the parent-child scenario 326, the recommendation information 340 can include information of places and services suitable for children, such as information of zoos, museums, playgrounds, and the like. In the commuting scenario 328, the recommendation information 340 can include current road conditions and optimal routes. In the electric scenario 329, the recommendation information 340 can include real-time changes in electric quantity, positions of charging piles, idle conditions of the charging piles, power levels of the charging piles and the like, or provide pop-up warnings in the case of low electric quantity.

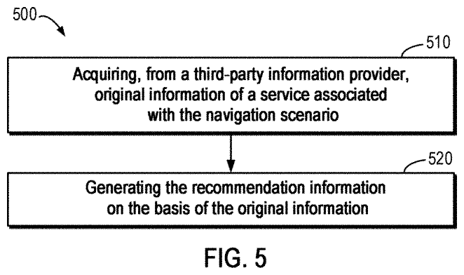

How to generate or determine the recommendation information 340 will be described below with reference to FIG. 5. FIG. 5 shows a flow diagram of a process 500 for generating the recommendation information according to some embodiments of the present disclosure. The process 500 can be implemented by the control system 130 in FIG. 1. For the convenience discussion, the description will be made with reference to FIG. 1.

At a block 510, in order to generate the recommendation information 340, the control system 130 can acquire, from a third-party information provider, original information of a service associated with the navigation scenario 320. In some embodiments, the control system 130 can acquire the original information from various third-party information providers such as weather applications, calendar applications, delicious food applications, map applications, and the like. The applications here include executable light applications and/or widgets (widget), etc.

It is taken as an example that the third-party information provider is a delicious food application, the control system 130 can request and acquire the original information from the delicious food application. In this case, the original information can be the business hours, delicious food information, pictures, and/or comments of restaurants provided by the delicious food application. For example, the original information can be “Open during 11:00-01:00 from Monday to Sunday; 2020 Jan. 24 to 2020 Jan. 25 closed; 2020 Jan. 26 to 2020 Jan. 31 11:00-21:00”.

Further, at a block 520, the control system 130 can generate the recommendation information 340 on the basis of the original information. In some embodiments, the control system 130 can reconstruct the original information into formatted information that has a format associated with the display system of the vehicle-mounted system 120. For example, the control system 130 can reconstruct unformatted original information “Open during 11:00-01:00 from Monday to Sunday” into formatted information represented by predetermined fields. For example, the formatted information represented by the predetermined fields can be “Business State: Open”, “Weekly: Monday, Tuesday, Wednesday, Thursday, Friday, Saturday, Sunday”, “Start Time: 11:00”, “End time: 01:00”. Thus, the control system 130 can well utilize and integrate the original information from various different third-party information providers.

Further, the control system 130 can determine, from the formatted information, an attribute value of an attribute associated with the recommendation information 340. For example, for formatted business hours, the control system 130 can determine the attribute value of the attribute of business state. The business state can include open, about to close, closed, about to open, and/or unknown, etc.

For example, the business state of being open can indicate that the current time is within a business hour range. For example, the remaining business hours exceed a first threshold time (e.g., 1.5 hours). The first threshold time can be set by the vehicle-mounted system 120. If a restaurant is open for 24 hours, the remaining business hours can be set to 24 hours.

The business state of being about to close can indicate that the current time is within the business hour range. For example, the remaining business hours are less than the first threshold time, but exceed a second threshold time (e.g., 0.5 hours). Similar to the first threshold time, the second threshold time can be set by the vehicle-mounted system 120. For example, if the remaining business hours of a restaurant are less than 1.5 hours, but exceed 0.5 hours, it can be considered that the business state of the restaurant is about to close.

The business state of being closed can indicate that the current time is not within the business hour range. For example, the remaining business hours are less than the second threshold time. For example, if the remaining business hours of a restaurant are less than 0.5 hours, it can be considered that the business state of the restaurant is closed.

The business state of being about to open can indicate that the current time is not within the business hour range, but is less than a third threshold time (e.g., 0.5 hours) from the business hours. Similar to the first and second threshold times, the third threshold time can be set by the vehicle-mounted system 120.

In addition, the business status of being unknown can indicate no business hour or incapability of reconstructing formatted business hours.

Further, the control system 130 can generate the recommendation information 340 on the basis of the attribute value. For example, the control system 130 can generate the recommendation information 340 on the basis of the business state. For example, the recommendation information 340 is the business states of restaurants or a list of open restaurants, which conforms to the format of the display system of the vehicle-mounted system 120. Thus, the map mode in the nighttime scenario 321 will display the business states of the restaurants or highlight the open restaurants, thereby helping the user 140 to make travel decisions.

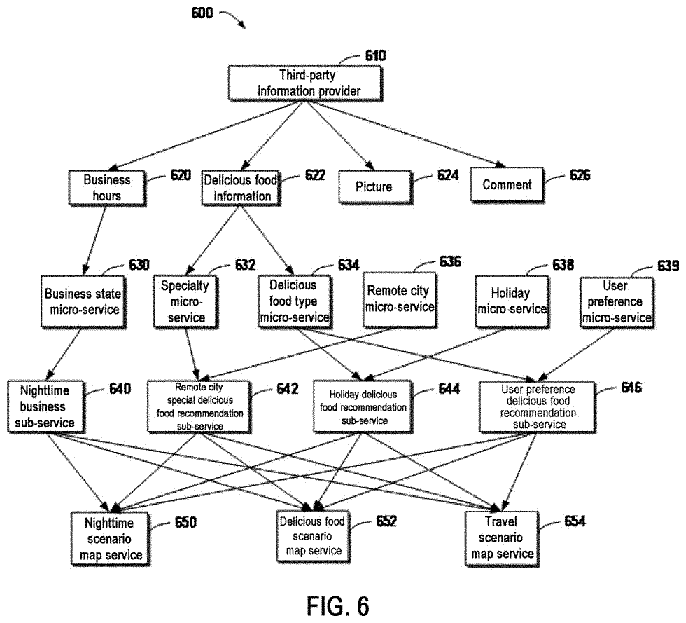

FIG. 6 shows a schematic diagram of an example recommendation information generation process 600 according to some embodiments of the present disclosure. As shown in FIG. 6, the control system 130 can acquire the original information from a third-party information provider 610. For example, the third-party information provider 610 can be a delicious food application, and the original information can be business hours 620, delicious food type 622, pictures 624, and/or comments 626 and the like of restaurants provided by the delicious food application.

The control system 130 can reconstruct the business hours 620, the delicious food types 622, the pictures 624, and/or the comments 626 and the like into formatted business hours, delicious food types, pictures, and/or comments and the like.

The control system 130 can include or call one or more micro-services. For example, these micro-services can include a business state micro-service 630, a specialty micro-service 632, a delicious food type micro-service 634, a remote city micro-service 636, a holiday micro-service 638, and/or a user preference micro-service 639, etc.

As an example, the business state micro-service 630 can determine the business state of a restaurant on the basis of formatted business hours. The specialty micro-service 632 can determine specialties of the restaurant on the basis of formatted delicious food information. The delicious food type micro-service 634 can determine the delicious food type of the restaurant on the basis of the formatted delicious food information. The remote city micro-service 636 can determine whether the user 140 is located in a different position on the basis of the current position of the user 140 and a usual position of the user 140. The holiday micro-service 636 can determine whether it is a holiday on the basis of the current time. The user preference micro-service 639 can determine the preferences of the user on the basis of the history or settings of the user.

One or more of the various micro-services can be integrated into a sub-service. The sub-service can call one or more micro-services. For example, the sub-service can include a nighttime business sub-service 640, a remote city special delicious food recommendation sub-service 642, a holiday delicious food recommendation sub-service 644, and/or a user preference delicious food recommendation sub-service 646, etc.

As an example, the nighttime business sub-service 640 can integrate the business state micro-service 630 determine restaurants that are open at night. The remote city special delicious food recommendation sub-service 642 can integrate the specialty micro-service 632 and the remote city micro-service 636, and determine specialties recommended to the user in a remote city, for example, recommending roast duck to a user who lives in Shanghai and is traveling in Beijing. The holiday delicious food recommendation sub-service 644 can integrate the delicious food type micro-service 634 and the holiday micro-service 638, and determine the delicious food recommended to the user on holidays, for example, recommending moon cakes to the user on the Mid-Autumn Festival. The user preference delicious food recommendation sub-service 646 can integrate the delicious food type micro-service 634 and the user preference micro-service 639, and determine preferred delicious food of the user.

Further, one or more of the various sub-services can be integrated into one service. The service can call one or more sub-services. For example, the service can include a nighttime scenario map service 650, a delicious food scenario map service 652, and/or a travel scenario map service 654, etc. As an example, the nighttime scenario map service 650, the delicious food scenario map service 652and the travel scenario map service 654 can all integrate the nighttime business sub-service 640, the remote city special delicious food recommendation sub-service 642, the holiday delicious food recommendation sub-service 644 and the user preference delicious food recommendation sub-service 646.

After determining the navigation scenario 320 in which the user 140 drives the transport means 110, the control system 130 can call the corresponding service to generate smarter and richer personalized recommendation information suitable for the navigation scenario. For example, when the navigation scenario 320 is the nighttime scenario 321, the control system 130 can call the nighttime scenario map service 650. When the navigation scenario 320 is the delicious food scenario 322, the control system 130 can call the delicious food scenario map service 652. When the navigation scenario 320 is the travel scenario 324, the control system 130 can call the travel scenario map service 654.

It should be understood that, the various micro-services, sub-services, services and the integration or call relationship therebetween shown in FIG. 6 are only exemplary, and the scope of the present invention is not limited thereto.

Further, the present invention is described above by taking the vehicle-mounted system 120 as an example. As described above, the present invention is not limited thereto, and any terminal device having a navigation function and a display system can implement the present invention. In the case of other terminal devices other than the vehicle-mounted system 120, the control system 130 can similarly provide differentiated smarter and richer personalized information recommendation and display suitable for the navigation scenario.

Specifically, the control system 130 of the terminal device can acquire a context associated with the terminal device, including an environment context, a time context, and/or a user context, etc. In some embodiments, for different terminal devices, the context can be different. For example, in the case where the user navigates by using a smartphone, the control system 130 does not need to acquire the type, the fuel state, the electric quantity state, the travel speed, the maintenance state, or the violations of the transport means, but can additionally acquire the positions of stations, the positions of idle bikes and the like in the vicinity of the current position of the user. Alternatively, when the smartphone is bound to the transport means, the control system 130 can also acquire the type, the fuel state, the electric quantity state, the travel speed, the maintenance state, or the violations of the transport means, etc.

The control system 130 can determine, on the basis of the context, a navigation scenario in which the user navigates by using the terminal device. In some embodiments, for different terminal devices, the navigation scenario can be different. For example, in the case where the user navigates by using the smartphone, the navigation scenario cannot include the electric scenario, but can include a riding scenario or an online car hailing scenario. However, where the smartphone is bound to the vehicle, the navigation scenario can also include the electric scenario.

Thus, the control system 130 can determine, on the basis of the navigation scenario, a map mode of a map that is displayed in the user interface of the terminal device. In some embodiments, for different terminal devices, the map mode can be different. It is still taken an example that the user navigates by using the smartphone, the map mode cannot include a map mode for the electric scenario, but can include a map mode for the riding scenario or the online car hailing scenario. For example, in the map mode for the riding scenario, the control system 130 can additionally recommend a safer riding route. In the map mode for the online car hailing scenario, the control system 130 can additionally recommend the information of idle online car hailing vehicles. Alternatively, when the smartphone is bound to the vehicle, the map mode can also include the map mode for the electric scenario.

In this way, the control system 130 can, according to the type of the terminal device, adaptively provide smarter and richer personalized information recommendation and display suitable for the navigation scenario.

Additionally, the map mode can also be manually selected by the user 140. For example, during an on-duty commuting time period, the user 140 can also manually select the map mode for the delicious food scenario, so as to acquire more information related to delicious food.

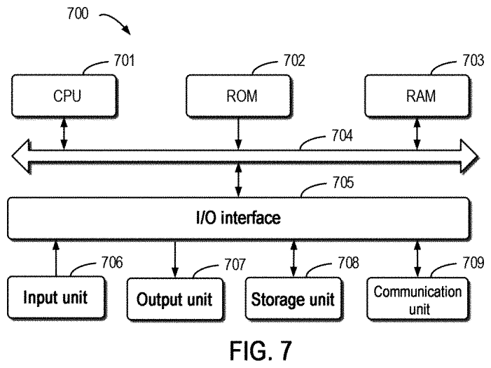

FIG. 7 shows a schematic block diagram of an electronic device 700 that can be used for implementing the embodiments of the present disclosure. The electronic device 700 can be used for implementing the control system 130 as shown in FIG. 1. For example, the control system 130 can be implemented as or included in the electronic device 700.

As shown in FIG.7, the electronic device 700 includes a central processing unit (CPU) 701, which can execute various appropriate actions and processing according to computer program instructions that are stored in a read only memory (ROM) 702 or are loaded from a storage unit 708 to a random access memory (RAM) 703. In the RAM 703, various programs and data required by the operation of the electronic device 700 can also be stored. The CPU 701, the ROM 702 and the RAM 703 are connected to each other by means of a bus 704. An input/output (I/O) interface 705 is also connected to the bus 704.

Various components in the electronic device 700 are connected to the I/O interface 705, including: an input unit 706, such as a keyboard, a mouse and the like; an output unit 707, such as various types of displays, a loudspeaker, and the like; a storage unit 708, such as a magnetic disk, an optical disk, and the like; and a communication unit 709, such as a network card, a modem, a wireless communication transceiver, and the like. The communication unit 709 allows the electronic device 700 to exchange information/data with other devices by means of a computer network such as the Internet and/or various telecommunication networks.

The processing unit 701 executes various methods and processing described above, for example, the processes 200 and 500. For example, in some embodiments, the processes 200 and 500 can be implemented as computer software programs, which are tangibly included in a machine-readable medium, such as the storage unit 708. In some embodiments, part or all of the computer programs can be loaded and/or installed on the electronic device 700 by means of the ROM 702 and/or the communication unit 709. When the computer programs are loaded into the RAM 703 and executed by the CPU 701, one or more steps of the processes 200 and 500 described above can be executed. Alternatively, in other embodiments, the CPU 701 can be configured to execute the processes 200 and 500 by any other suitable manners (e.g., by means of firmware).

In some embodiments, a computer program product can also be provided. The computer program product can include a computer program, and when executed by the processor 701, the computer program implements the processes 200 and 500.

The above functions described herein can be executed, at least in part, by one or more hardware logic components. For example, without limitation, exemplary types of hardware logic components that can be used include: a field programmable gate array (FPGA), an application specific integrated circuit (ASIC), an application specific standard product (ASSP), a system on chip (SOC), a complex programmable logic device (CPLD), etc.

Program codes for implementing the method of the present disclosure can be compiled in any combination of one or more programming languages. These program codes can be provided for a general-purpose computer, a special-purpose computer or processors or controllers of other programmable data processing apparatuses, such that the program codes, when executed by the processors or the controllers, implement functions/operations specified in flow diagrams and/or block diagrams. The program codes can be executed entirely on a machine, partially on the machine, partially on the machine as a stand-alone software packet, and partly on a remote machine or entirely on the remote machine or a server.

In the context of the present disclosure, a machine-readable medium can be a tangible medium that can contain or store a program for use by or in combination with an instruction execution system, apparatus or device. The machine-readable medium can be a machine-readable signal medium or a machine-readable storage medium. The machine-readable medium can include, but is not limited to, electronic, magnetic, optical, electromagnetic, infrared, or semiconductor systems, apparatuses or devices, or any suitable combination of the foregoing content. More specific examples of the machine-readable storage medium would include one or more wire-based electrical connections, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the foregoing content.

In addition, although various operations are depicted in a particular order, this should be understood to require that such operations are executed in the particular order shown or in a sequential order, or that all illustrated operations should be executed to achieve desired results. Under certain environments, multi-task and parallel processing may be advantageous. Likewise, although the above discussion contains several specific implementation details, these should not be construed as limitations to the scope of the present disclosure. Some features described in the context of separate embodiments can also be implemented in combination in a single implementation. Conversely, various features described in the context of a single implementation can also be implemented in a plurality of implementations separately or in any suitable sub-combination manner.

Although the present theme has been described in language specific to structural features and/or logical actions of the method, it should be understood that the theme defined in the appended claims is not necessarily limited to the specific features or actions described above. On the contrary, the specific features and actions described above are merely example forms of implementing the claims.

1. A method for information display, comprising:
acquiring a context associated with at least one of a terminal device and a user;
determining, on the basis of the context, a navigation scenario in which the user navigates by using the terminal device; and
determining, on the basis of the navigation scenario, a map mode of a map that is displayed in a user interface of a display system of the terminal device.

2. The method according to claim 1, wherein the terminal device is a vehicle-mounted system, and the user is a vehicle driver or passenger.

3. The method according to claim 1, wherein the context comprises at least one of the following:
an environment context, which indicates information associated with an environment where the terminal device is located;
a time context, which indicates information of time associated with operation of the terminal device; and
a user context, which indicates information associated with the user.

4. The method according to claim 1, wherein the navigation scenario comprises at least one of the following:
a nighttime scenario,
a delicious food scenario,
a travel scenario,
a parent-child scenario,
a commuting scenario, and
an electric scenario.

5. The method according to claim 1, wherein determining the map mode comprises:
on the basis of the navigation scenario, determining the following:
recommendation information regarding the navigation scenario and associated with the map, and
a layout of the recommendation information in the user interface; and
displaying, on the basis of the layout, the recommendation information in the user interface, so as to generate the map mode.

6. The method according to claim 5, wherein determining the layout comprises:
selecting, on the basis of the navigation scenario, a target layout template from a plurality of predetermined layout templates, wherein the target layout template indicates an area used for displaying the recommendation information; and
determining the layout on the basis of the target layout template.

7. The method according to claim 5, wherein generating the recommendation information comprises:
acquiring, from a third-party information provider, original information of a service associated with the navigation scenario; and
generating the recommendation information on the basis of the original information.

8. The method according to claim 7, wherein generating the recommendation information on the basis of the original information comprises:
reconstructing the original information into formatted information that has a format associated with the display system;
determining, from the formatted information, an attribute value of an attribute associated with the recommendation information; and
generating the recommendation information on the basis of the attribute value.

9. An electronic device, comprising:
at least one processing unit; and
at least one memory,
wherein the at least one memory is coupled to the at least one processing unit and stores instructions executed by the at least one processing unit, and when executed by the at least one processing unit, the instructions enable the device to execute actions comprising:
acquiring a context associated with at least one of a terminal device and a user;
determining, on the basis of the context, a navigation scenario in which the user navigates by using the terminal device; and
determining, on the basis of the navigation scenario, a map mode of a map that is displayed in a user interface of a display system of the terminal device.

10. The device according to claim 9, wherein the terminal device is a vehicle-mounted system, and the user is a vehicle driver or passenger.

11. The device according to claim 9, wherein the context comprises at least one of the following:
an environment context, which indicates information associated with an environment where the terminal device is located;
a time context, which indicates information of time associated with operation of the terminal device; and
a user context, which indicates information associated with the user.

12. The device according to claim 9, wherein determining the map mode comprises:
on the basis of the navigation scenario, determining the following:
recommendation information regarding the navigation scenario and associated with the map, and
a layout of the recommendation information in the user interface; and
displaying, on the basis of the layout, the recommendation information in the user interface, so as to generate the map mode.

13. The device according to claim 12, wherein determining the layout comprises:
selecting, on the basis of the navigation scenario, a target layout template from a plurality of predetermined layout templates, wherein the target layout template indicates an area used for displaying the recommendation information; and
determining the layout on the basis of the target layout template.

14. A computer-readable storage medium, wherein a computer program is stored thereon, and when executed by a processor, the program implements the method according to claim 1.

15. A computer program product, comprising a computer program, wherein when executed by a processor, the computer program implements the method according to claim 1.
